(19) United States
(12) Patent Application Publication
(10) Pub. No.: US 2026/0257890 A1
(43) Pub. Date: Sep. 3, 2026

(54) ELEVATOR SYSTEM AND CONTROL METHOD THEREOF

(71) Applicant: HYUNDAI ELEVATOR CO., LTD, Chungcheongbuk-do (KR)

(72) Inventors: Joong Jae KIM, Chungcheongbuk-do (KR); Won Chul CHOI, Gyeonggi-do (KR)

(21) Appl. No.: 18/866,631

(22) PCT Filed: Jun. 14, 2024
(86) PCT No.: PCT/KR2024/008244

§ 371 Date: Nov. 18, 2024

(30) Foreign Application Priority Data
Jun. 20, 2023 (KR) 10-2023-0078973
Sep. 20, 2023 (KR) 10-2023-0125380

(51) Int. Cl. B66B 5/00

(52) U.S. Cl. CPC B66B 5/0012

(57) ABSTRACT

An elevator system is disclosed. The elevator system includes: an imaging unit configured to distinguish, detect, and track an object in an elevator car; and a controller configured to control and manage operation of an elevator based on information regarding whether the object is aboard the elevator car, the information being received from the imaging unit, wherein, when the object being tracked by the imaging unit is obscured and undetectable in an image, determination as to whether the object is aboard the elevator car is corrected based on additional information.

### TECHNICAL FIELD

The present invention relates to an elevator system and a control method thereof.

### BACKGROUND ART

An elevator includes an elevator car configured to move along a hoistway formed inside a building in a vertical direction, a hoist machine configured to generate power to raise or lower the elevator car, and a power transmission member that transmits the power of the hoist machine to the elevator car.

An elevator car travels along a hoistway formed inside a building in the vertical direction. A motor for power generation, a hoist machine, and the like are installed to lift or descend the elevator car. One or more elevators installed inside a building may be integrally controlled and managed.

Such an elevator enables vertical movement of non-robot and/or robot objects, such as persons, cargo, animals, plants and the like, within a building.

In recent years, robots have been used to provide various services. However, since commercially available robots can move horizontally but are not designed to move in the vertical direction, there is a need for means for movement between floors in a building.

As a result, various technologies for interlocking control between the robots and the elevator are developed to allow the robots to board the elevator and to travel between floors in a building.

In particular, in order to control an object, such as a robot and the like, to move smoothly between floors using an elevator in a building, information as to whether the object is aboard the elevator car is important.

### PRIOR ART REFERENCE

Korean Patent Laid-open Publication No. 10-2022-0139528

### DISCLOSURE

### Technical Problem

It is an aspect of the present invention to provide an elevator system that can improve reliability of information as to whether an object is aboard an elevator car.

### Technical Solution

In accordance with one aspect of the present invention, there is provided an elevator system including: an imaging unit configured to distinguish, detect, and track an object in an elevator car; and a controller configured to control and manage operation of an elevator based on information regarding whether the object is aboard the elevator car, the information being received from the imaging unit, wherein, when the object being tracked by the imaging unit is obscured and undetectable in an image, determination as to whether the object is aboard the elevator car is corrected based on additional information.

The additional information may include at least one of information as to whether a door of the elevator car is open, a weight change inside the elevator car, a short-range signal sent from the object, a location signal sent from the object, monitoring information regarding a travel path of the object, and destination information of the object.

The object may include a robot or a non-robot.

When the object being tracked by the imaging unit inside the elevator car is not obscured by another object in the image or is obscured only for a short period of time within a preset value such that it is determined that the imaging unit continues to track the object, priority may be given to image information.

When the door of the elevator car has never been opened in a situation where it is determined that the object is aboard the elevator car, it may be determined that the object is aboard the elevator car even when the object is obscured and undetectable in the image.

The elevator system may further include at least one weight sensor disposed in a plurality of zones into which a floor of the elevator car is divided, wherein determination as to whether the object is aboard the elevator car is made based on increase or decrease in weight in each zone by specifying a zone where the object has been present (“specified zone”).

When a weight of the specified zone decreases within a tolerance of a value preset as a weight of the object and there is no corresponding increase in weight in another zone, it may be determined that the object has alighted from the elevator car.

When the location signal sent from the object persists for a preset period of time or more, the location signal sent from the object may be used alone or in combination with other additional information to determine whether the object is aboard the elevator car.

In accordance with another aspect of the present invention, there is provided a method of controlling the elevator system, which includes: determining whether an object is obscured in an image; and improving determination reliability using additional information.

The additional information may include information as to whether a door of the elevator car is open and the method may further include: determining whether the object has been aboard the elevator car before being obscured in the image; and determining whether the door of the elevator car has ever been opened.

The additional information may include a weight change inside the elevator car and the method may further include: determining whether there is a weight decrease in a specified zone; and determining whether there is a corresponding weight increase in a zone other than the specified zone.

The additional information may include a location signal sent from the object and the method may further include: determining whether the object has been aboard the elevator car before being obscured in the image; and determining whether the location signal sent from the object persists inside the elevator car for a preset period of time or more.

### Advantageous Effects

According to the present invention, the elevator system can improve reliability in determination as to whether an object is aboard an elevator even when the object is obscured and undetectable in an image.

### DESCRIPTION OF DRAWINGS

FIG. 1 is a schematic view of a robot and a non-robot in an elevator car.

FIG. 2 is a schematic view of an elevator system according to one embodiment of the present invention.

FIG. 3 is a schematic view of one example of an interior image of an elevator car recognized by an image recognition device.

FIG. 4 is a schematic view of another example of the interior image of the elevator car recognized by the image recognition device.

FIG. 5 is a schematic flowchart illustrating a method of controlling an elevator system according to one embodiment of the present invention.

FIG. 6 to FIG. 8 are schematic flowcharts illustrating examples that embody the step of “improving determination reliability using additional information”.

### BEST MODE

Hereinafter, exemplary embodiments of the present invention will be described in detail with reference to the accompanying drawings. The present invention may be applied in various ways to the fields of robot control and elevator control. In addition, it should be understood that the following embodiments may be modified into various forms and are not intended to limit the scope of the present invention.

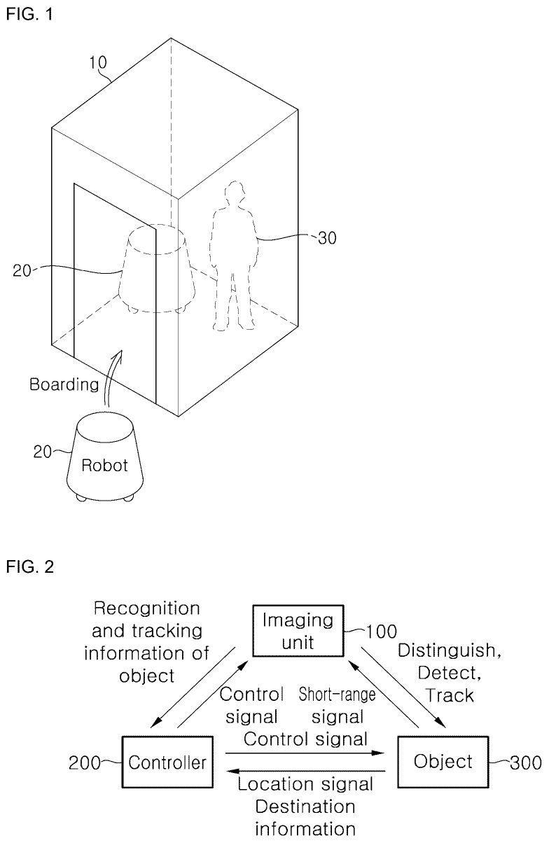

FIG. 1 schematically shows an elevator car 10 with a robot 20 and a non-robot 30, such as a human, on board.

Referring to FIG. 1, an elevator system according to the present invention may include an elevator car 10, which allows not only a robot 20 but also a non-robot 30, such as a person, cargo, animal or plant, to board the elevator car 10. The robot 20 may include a service robot configured to provide service to at least one floor in a building.

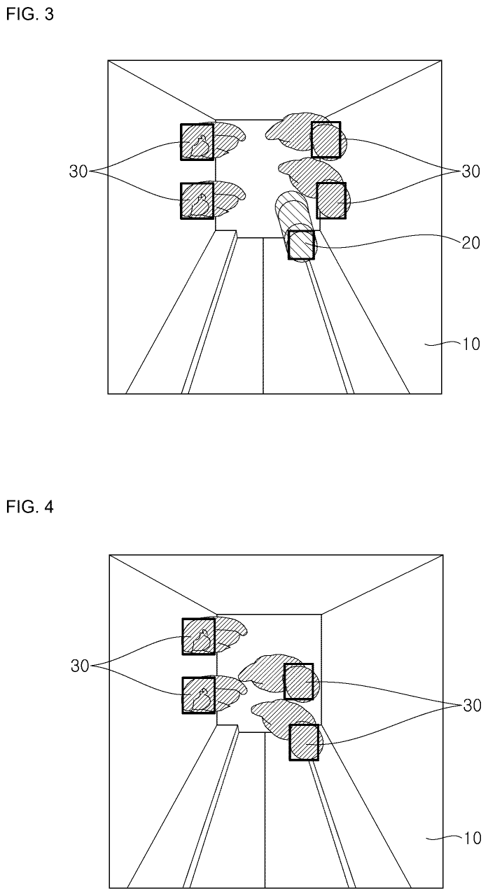

FIG. 2 is a schematic view of an elevator system according to one embodiment of the present invention. Referring to FIG. 2, the elevator system according to this embodiment includes an imaging unit 100 and a controller 200.

The imaging unit 100 may include an image recognition device, such as a camera, CCTV, and the like, configured to photograph the interior of the elevator car 10. The imaging unit 100 may be configured to distinguish, detect, and recognize one or more objects 300 within the elevator car 10 through computation of image information regarding the interior of the elevator car 10 recognized by the image recognition device. The objects 300 may include robots 20 and non-robots 30, such as persons, cargo, animals, plants, and the like. The imaging unit 100 can improve capability of distinguishing and detecting the objects 300 through machine learning.

The imaging unit 100 may track at least one object recognized thereby. The object under tracking of the imaging unit may be visually displayed in an image. An administrator (human) may identify the object under tracking of the imaging unit through a visual indication in the image. The imaging unit 100 may send recognition and tracking information regarding the object 300 to the controller 200 in real time.

When the object 300 is a mechanical device, such as a robot, the object 300 may send a short-range signal, such as a radio signal and the like, to the image recognition device within the elevator car 10. The imaging unit 100 may be configured to determine whether the object 300 is aboard the elevator car 10 based on the short-range signal received by the image recognition device.

The controller 200 may be configured to control and manage the overall operation of one or more elevators installed in a building. The controller 200 may send control signals to the imaging unit 100 and the object 300, such as a robot and the like. The controller 200 may perform group management of the elevators. The controller 200 may include a terminal, a surveillance panel, and the like that perform monitoring of the elevators.

When the object 300 is a mechanical device, such as a robot and the like, the object 300 may send a location signal to the controller 200. The controller 200 may monitor a traveling path of the object 300 based on the location signal sent from the object 300. The controller 200 may determine whether the object 300 is aboard the elevator. In addition, when the object 300 is a mechanical device, such as a robot and the like, destination information of the object 300 may be sent to the controller 200.

The controller 200 may receive information as to whether the object is on board, which is sent from the imaging unit 100, and may control and manage operation of the elevator based on the received information. In particular, the controller 200 may use the information to determine whether a door of the elevator car 10 is open or closed.

The controller 200 may determine whether the object 300 is aboard the elevator based on information regarding a location of the object 300 (hereinafter referred to as “location signal information”), which is basically determined by the location signal sent from the object 300, and information as to whether the object 300 is on board sent from the imaging unit 100 (hereinafter referred to as “image information”).

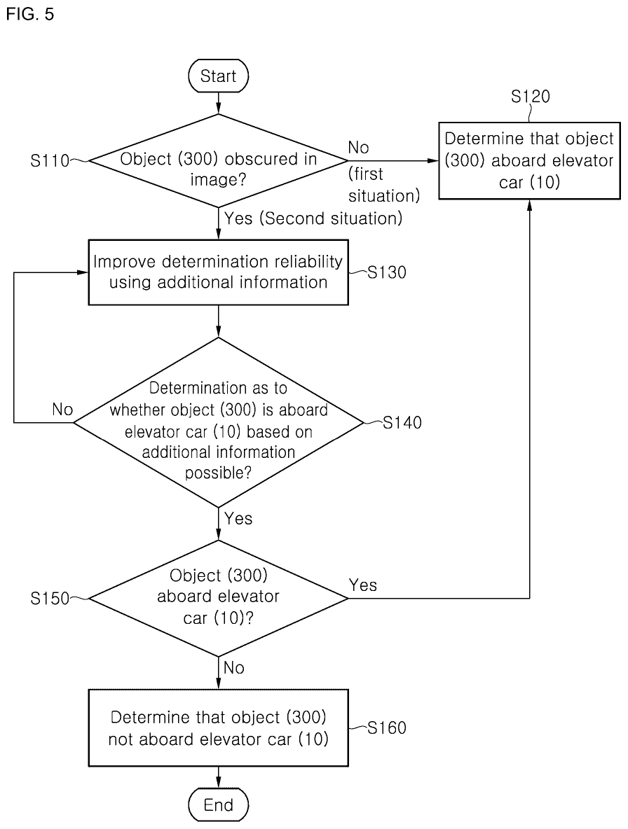

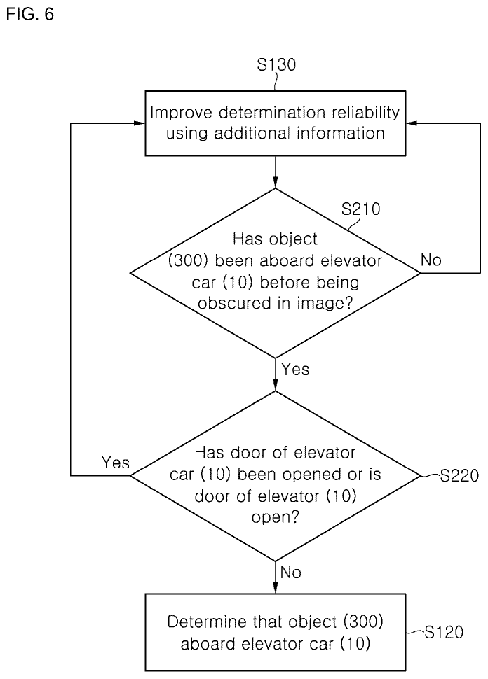

FIG. 3 is a schematic view of one example of an interior image of an elevator car recognized by the image recognition device and FIG. 4 is a schematic view of another example of the interior image of the elevator car recognized by the image recognition device.

Referring to FIG. 3 and FIG. 4, the objects 300 being tracked by the imaging unit 100 include four persons 30 and one robot 20. In FIG. 3, since all of the non-robots 30 and the robot 20 present in the elevator car are detected in an image, high reliability can be imparted to the image information. However, if some of the objects 300 are obscured as in FIG. 4, it can be unclear whether the robot 20 is aboard the elevator car but is obscured by a person 30 or whether the robot 20 is undetectable in the image since the robot 20 alighted therefrom.

Accordingly, in certain cases, the image information may be prioritized to determine whether the object 300 is aboard the elevator car, or the determination result may be corrected using additional information to improve reliability of determination as to whether the object 300 is aboard the elevator car. Next, this configuration will be discussed in more detail.

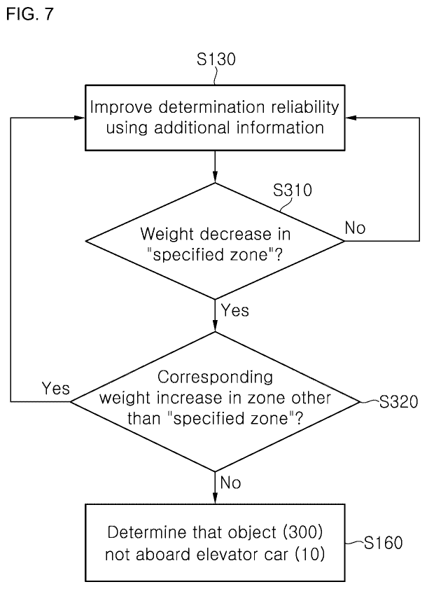

FIG. 5 is a schematic flowchart of a method of controlling the elevator system according to one embodiment of the present invention.

Referring to FIG. 5, the control method according to this embodiment includes the steps of: determining whether an object 300 is obscured in an image (S110); determining that the object 300 is aboard the elevator car 10 (S120); improving determination reliability using additional information (S130); determining whether the additional information enables determination as to whether the object 300 is aboard the elevator car 10 (S140); determining that the object 300 is aboard the elevator car 10 (S150); and determining that the object 300 is not aboard the elevator car 10 (S160).

### (1) Step of Determining Whether Object 300 is Obscured in Image (S110)

When it can be determined that the imaging unit 100 continues to track the object 300 (first situation), high reliability can be imparted to the image information. Here, the first situation may include, for example, a case where the object 300 being tracked by the imaging unit 100 inside the elevator car 10 is not obscured by another object in an image or is obscured only for a short period of time within a preset value, as shown in FIG. 3.

In the first situation, the image information is prioritized to determine that the object 300 is aboard the elevator car 10 based on the image information (S120), even when location signal information of the object 300 is not captured or is captured outside the corresponding elevator.

Upon determining that the object 300 being tracked by the imaging unit 100 is not detected in the image (second situation), it may be unclear whether the object 300 is aboard the elevator car 10. Here, the second situation may include, for example, a case where the object 300 being tracked by the imaging unit 100 inside the elevator car 10 is obscured by another object in the image for a period of time exceeding a preset value, as shown in FIG. 4.

In the second situation, it may be uncertain whether the object 300 is aboard the elevator car 10 but is obscured by another object, or whether the object 300 has alighted from the elevator car and is not present therein. Accordingly, in this case, determination reliability may be improved through correction with additional information (S130).

When the additional information does not allow determination as to whether the object 300 is aboard the elevator car 10 (S140), the operation of improving determination reliability is repeated using additional information. When the additional information enables determination as to whether the object 300 is aboard the elevator car 10 (S140), determination as to whether the object (300) is aboard the elevator car 10 is performed (S150).

The additional information for improvement in determination reliability may include at least one of 1) information as to whether a door of the elevator car 10 is open, 2) a weight change inside the elevator car 10, 3) a short-range signal sent from the object 300, 4) a location signal sent from the object 300, 5) monitoring information regarding a travel path of the object 300, and 6) destination information of the object 300.

### 1) Whether Door of Corresponding Elevator Car 10 is Open

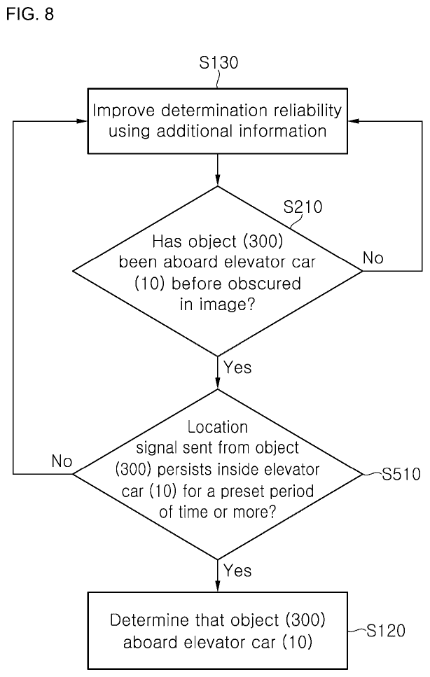

FIG. 6 is a schematic flowchart of one example of the step of “improving determination reliability using additional information (S130)”. Referring to FIG. 6, when the additional information relates to “whether the door of the elevator car 10 is open,” the method according to the embodiment of the present invention may further include the step (S210) of determining whether the object 300 has been aboard the elevator car 10 before being obscured in the image and the step (S220) of determining whether the door of the elevator car 10 has ever been opened.

In a situation where it is determined based on the location signal information and the image information that the object 300 has been aboard the elevator car 10 before being obscured in the image (S210), upon determining that the door of the elevator car 10 has never been opened (S220), it may be determined that the object 300 is aboard the elevator car 10 even when the object 300 is obscured and undetectable in the image (S120).

When it cannot be determined based on the location signal information and the image information that the object 300 has been aboard the elevator car 10 before being obscured in the image (S210), other additional information may be used to improve determination reliability (S130).

In the situation where it is determined based on the location signal information and the image information that the object 300 has been aboard the elevator car 10 before being obscured in the image (S210), upon determining that the door of the elevator car 10 has been opened (S220), there is a possibility that the object 300 has alighted from the elevator car 10. In addition, when the door of the elevator car 10 is in an open state, the object 300 may continue to be aboard the elevator car 10 or may be in an alighting state or in an alighted state therefrom.

Accordingly, in the situation where it is determined based on the location signal information and the image information that the object 300 has been aboard the elevator car 10 before being obscured in the image (S210), upon determining that the door of the elevator car 10 has been opened or is in an open state (S220), additional information is needed to determine whether the object 300 is aboard the elevator car 10 and a current state of the object 300 (S220).

### 2) Weight Change Inside Corresponding Elevator Car 10

When the object 300 has alighted from the object 300, the weight inside the elevator car 10 can be reduced by the weight of the object 300. Accordingly, it is possible to determine based on this result whether the object 300 is aboard or not.

In general, when the object 300 is obscured by another object, there is a high possibility that the object 300 is still located in a zone where the object 300 has been located before being obscured in the image, since the object 300 is almost immobile due to a great number of persons, robots, and the like in the elevator car.

A floor of the elevator car 10 may be divided into a plurality of zones. Each of the plurality of zones may be provided with at least one weight sensor. By the weight sensor disposed in each zone, the controller 200 may specify a zone where the object 300 has been located before being obscured in the image (hereinafter referred to as “specified zone”). Then, the controller 200 may determine whether the object 300 is aboard the elevator car 10 based on increase or decrease in weight in each zone.

In particular, if the object 300 being tracked by the imaging unit is a mechanical device, such as a robot and the like, the weight of the object 300 can be known in advance. Thus, when the weight of the specified zone decreases within a tolerance of a value preset as the weight of the object 300, it may be determined that the object 300 has moved from the specified zone, and when there is no corresponding increase in weight in another zone, it may be determined that the object 300 has alighted from the corresponding elevator car 10.

A pre-installed load cell may also be used to measure the interior weight of the elevator car 10.

FIG. 7 is a schematic flowchart of one example of the step of “improving determination reliability using additional information (S130)”. Referring to FIG. 7, when the additional information relates to “a weight change inside the corresponding elevator car 10,” the method according to the embodiment of the present invention may further include the step (S310) of determining whether there is a weight decrease in the “specified zone” and the step (S320) of determining whether there is a corresponding weight increase in a zone other than the “specified zone”.

Upon determining that there is a weight decrease in the “specified zone” (S310) and that there is no corresponding weight increase in a zone other than the “specified zone” (S320), it may be determined that the object 300 is not aboard the elevator car 10 (S160).

Upon determining that there is a weight decrease in the “specified zone” (S310) and that there is a corresponding weight increase in a zone other than the “specified zone” (S320), determination reliability may be improved by additional information (S130), since it is unknown whether the object 300 has only changed position within the elevator car 10 or has alighted from the elevator car 10.

If there is no weight decrease in the “specified zone” (S310), determination reliability may be improved by additional information (S130).

3) Short-Range Signal from Object 300.

When the object 300 is a mechanical device, such as a robot and the like, the object 300 may send a short-range signal, such as a radio signal and the like. The short-range signal sent from the object 300 may be received by the image recognition device installed inside the elevator car 10 to determine whether the object 300 is aboard the elevator car 10.

4) Location Signal Sent from Object 300

FIG. 8 is a schematic flowchart of one example of the step of “improving determination reliability using additional information (S130)”. Referring to FIG. 8, when the additional information is a location signal sent from the object 300, the method according to the embodiment of the present invention may further include the step (S210) of determining whether the object 300 has been aboard the elevator car 10 before being obscured in the image, and the step (S510) of determining whether the location signal sent from the object 300 persists inside the elevator car 10 for a preset period of time or more.

In a situation where it is determined based on the location signal information and the image information that the object 300 has been aboard the elevator car 10 before being obscured in the image (S210), when the controller 200 recognizes that the location signal sent from the object 300 persists inside the elevator car 10 for a preset period of time or more (S510), it may be determined that the object 300 is aboard the corresponding elevator car 10 (S120), even when the object 300 is obscured and undetectable in the image.

In the situation where it is determined based on the location signal information and the image information that the object 300 has been aboard the elevator car 10 before being obscured in the image (S210), when the controller 200 recognizes that the location signal sent from the object 300 does not persist inside the elevator car 10 for a preset period of time or more (S510), determination reliability may be improved by other additional information (S130).

Upon determining based on the location signal information and the image information that the object 300 has not been aboard the elevator car 10 before being obscured in the image (S210), determination reliability may be improved by other additional information (S130).

Even when the object 300 is obscured and undetectable in the image with the door of the elevator car 10 open, the location signal sent from the object 300 may indicate that the object 300 is alighting from the elevator car 10. Then, there is a high possibility that the object 300 is alighting from the corresponding elevator car 10.

Thus, when the location signal sent from the object 300 persists for a preset period of time or more, the location signal sent from the object 300 may be used alone or in combination with other additional information to determine whether the object 300 is aboard the elevator car.

### 5) Monitoring Information Regarding Travel Path of Object 300

The controller 200 may monitor the travel path of the object 300 based on the location signal sent from the object 300. Referring to the monitoring information regarding the travel path of the object 300 produced by the controller 200, it may be determined whether the object 300 has alighted from the corresponding elevator car 10 or continues to be aboard therein.

### 6) Destination Information of Object 300

When the object 300 is a mechanical device, such as a robot and the like, the destination information of the object 300 may be sent to the controller 200. Referring to the destination information of the object 300, it may be determined whether the object 300 has alighted from the corresponding elevator car 10 or remains aboard.

According to the present invention, when the object 300 being tracked by the imaging unit 100 is obscured and undetectable in an image, the controller 200 may correct an error of providing information determining that the object 300 is not aboard the elevator car 10 even though the object 300 is actually aboard the elevator car 10. Even when the object 300 being tracked by the imaging unit 100 is obscured and undetectable in the image, the elevator system can improve reliability of determination as to whether the object 300 is aboard the elevator car 10.

Although some embodiments have been described herein, it will be apparent that these embodiments are given by way of illustration only and that various modifications, variations, and alterations can be made by those skilled in the art without departing from the spirit and scope of the invention.

<List of Reference Numerals>

| | |
|---|---|
| 10: Elevator car | 20: Robot |
| 30: Non-robot | 100: Imaging unit |
| 200: Controller | 300: Object |

1. An elevator system comprising:
an imaging unit configured to distinguish, detect, and track an object in an elevator car; and
a controller configured to control and manage operation of an elevator based on information regarding whether the object is aboard the elevator car, the information being received from the imaging unit,
wherein, when the object being tracked by the imaging unit is obscured and undetectable in an image, determination as to whether the object is aboard the elevator car is corrected based on additional information.

2. The elevator system according to claim 1, wherein the additional information comprises at least one of information as to whether a door of the elevator car is open, a weight change inside the elevator car, a short-range signal sent from the object, a location signal sent from the object, monitoring information regarding a travel path of the object, and destination information of the object.

3. The elevator system according to claim 1, wherein the object comprises a robot or a non-robot.

4. The elevator system according to claim 1, wherein, when the object being tracked by the imaging unit inside the elevator car is not obscured by another object in the image or is obscured only for a short period of time within a preset value such that it is determined that the imaging unit continues to track the object, priority is given to image information.

5. The elevator system according to claim 1, wherein, when the door of the elevator car has never been opened in a situation where a determination has been made that the object is aboard the elevator car, a determination is made that the object is aboard the elevator car even when the object is obscured and undetectable in the image.

6. The elevator system according to claim 1, further comprising:
at least one weight sensor disposed in a plurality of zones divided on a floor the elevator car,
wherein determination as to whether the object is aboard the elevator car is made based on increase or decrease in weight in each zone by specifying a zone where the object has been present (“specified zone”).

7. The elevator system according to claim 6, wherein, when a weight of the specified zone decreases within a tolerance of a value preset as a weight of the object and there is no corresponding increase in weight in another zone, a determination is made that the object has alighted from the elevator car.

8. The elevator system according to claim 1, wherein, when the location signal sent from the object persists for a preset period of time or more, the location signal sent from the object is used alone or in combination with other additional information to determine whether the object is aboard the elevator car.

9. A method of controlling the elevator system according to any one of claims 1 to 8, comprising:
determining whether an object is obscured in an image; and
improving determination reliability using additional information.

10. The method of controlling the elevator system according to claim 9, further comprising:
determining whether the object has been aboard the elevator car before being obscured in the image; and
determining whether a door of the elevator car has been opened,
wherein the additional information comprises information as to whether the door of the elevator car is open.

11. The method of controlling the elevator system according to claim 9, further comprising:
determining whether there is a weight decrease in a specified zone; and
determining whether there is a corresponding weight increase in a zone other than the specified zone,
wherein the additional information comprises a weight change inside the elevator car.

12. The method of controlling the elevator system according to claim 9, further comprising:
determining whether the object has been aboard the elevator car before being obscured in the image; and
determining whether a location signal sent from the object persists inside the elevator car for a preset period of time or more,
wherein the additional information comprises the location signal sent from the object.
